(19) United States
(12) Patent Application Publication
(10) Pub. No.: US 2009/0056640 A1
(43) Pub. Date: Mar. 5, 2009

(54) Animal Training Device

(76) Inventor: Fritz Gross, Stuttgart (DE)

Correspondence Address: HARNESS, DICKEY & PIERCE, P.L.C., P.O. BOX 828, BLOOMFIELD HILLS, MI, 48303, US

(21) Appl. No.: 11/660,286

(22) PCT Filed: Aug. 1, 2005
(86) PCT No.: PCT/DE2005/001354

§ 371 Date: Oct. 22, 2008

(30) Foreign Application Priority Data
Aug. 16, 2004 (DE) 102004041001.1
Apr. 28, 2005 (DE) 102005019774.4
May 6, 2005 (DE) 202005007498.5
Jun. 21, 2005 (DE) 202005010210.5
Jul. 25, 2005 (DE) 202005011646.7

(51) Int. Cl. A01K 15/02; A01K 5/02

(52) U.S. Cl. 119/702; 119/57.92; 119/707; 119/51.12

(57) ABSTRACT

The invention relates to an animal exercise device, which is designed to challenge the natural instincts of animals, in particular dogs and cats, when hunting for food or toys. According to the invention, the food and toys are displayed and then disappear before the animal has caught them. The animal finally receives the food, but only after expending a certain amount of energy, thus mirroring nature.

This development is intended to be a training aid for animals.

The animal is challenged without the absolute need for a human to be present.

Food (toy or other attractive objects) is made accessible and before the animal reaches the food, it can be made inaccessible.

It is also possible that the animal sometimes still reaches the food or the object, but that it nonetheless moves farther away and ultimately can no longer be reached.

Naturally, the animal should be able to reach the food so that it remains motivated.

It is intended for all types of animal, but specifically for dogs and cats. The most varied designs are conceivable.

They can be modified accordingly, depending on the behavioral characteristics of the individual types of animal.

For example, for cats, for which the aspect of creeping and stalking is of greater importance. Even in these instances, it is important that food appears and disappears again selectively.

Thus designs are possible in which the treat is extended from a hatch and retracted again after a specific time. They are suitable as an activity for all types of animal, but hereinafter are described specifically for cats since their application is easiest to understand with this type of animal.

Cats can often not be allowed outside, particularly in major cities.

Then, at specific times they are given their usually rich food, which is not conducive to their health.

Unlike their natural surroundings, they do not have to do anything to hunt their prey. It is more the natural instinct of the cat for it to obtain its food by creeping up, waiting, stalking and leaping.

Thus, devices are presented which mimic this natural process and thus occasionally challenge the cat physically and mentally, for example, when the owner is away from home during the day.

First of all, a component is needed which ensures that the mouse (food) appears occasionally and disappears occasionally. This arouses the attention of the cat, it watches and creeps up. The moving part can in part imitate the appearance of a mouse, but in the last instance it will be a food dish in which there is tasty food.

The food dish can move back and forth at regular intervals, for example, on a rail a belt or on a linkage, etc. (in front of and into the food bin F), but it could also be controlled such that it excites even more attention by irregular movements (changing speed, pauses, different lines of movement). The most varied designs are conceivable to achieve a backward and forward motion.

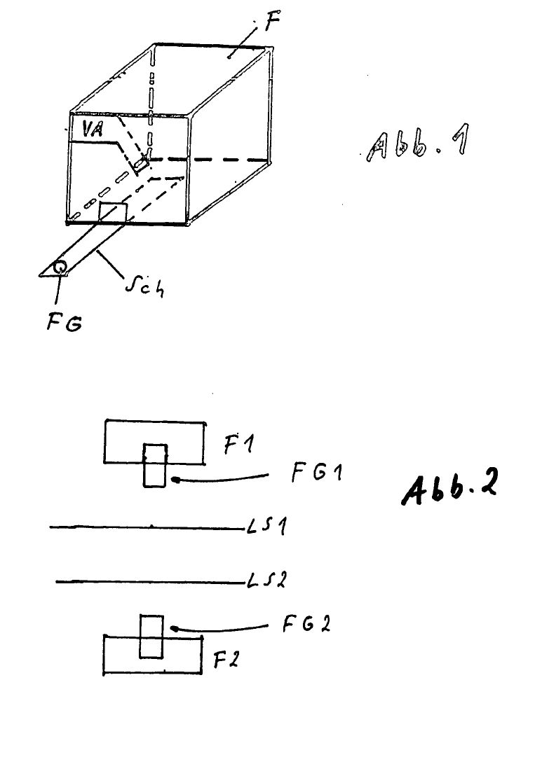

FIG. 1 shows an example of a food bin F having a food dish FG moving, for example, on a rail Sch.

The entire ensemble must be electronically controlled, the food dish is either filled once by the cat owner and then emptied by the cat at some point, or the food dish could also be designed such that, following a catch, it is refilled in the food bin from a delivery section VA, by means of an automatic control with suitable mechanical apportionment.

A possible arrangement could look like FIG. 2.

The food bin F stands against a wall or in the corner of a room. At some distance from it, a light curtain LS is set up. As soon as the cat crosses it, the food dish FG is instantly pulled into the food bin and remains there for the time being, out of reach of the cat. The distance of the light curtain LS from the food dish FG must be great enough that the cat is not able to reach the food dish FG in time since it is retracted instantly when the light curtain is triggered.

So that the cat does not wait forever, it would make sense to set up a second system in the room which is electronically connected to the first system (F2, LS2).

When the cat runs through the light curtain LS1, FG1 is pulled into the food bin F1. At the same time, the food dish FG2 is set in motion, electronically controlled and with a varying time delay. This diverts the attention of the cat to this food dish and it commences a new attack. As soon as it activates the light curtain LS2 as it is creeping up, the game is reversed and food dish F1 is again the focus of attention.

The cat owner can set up objects between LS1 and LS2 which help the cat to hide and stalk.

How does it all end? After the cat has made perhaps 10 unsuccessful attempted attacks, the electronic controls could now switch so that when, for example, light curtain LS2 is crossed, food dish FG2 moves out and the remains there. The cat would be able to eat the food in peace. If it then goes through light curtain LS1, the same thing happens and the cat has its well deserved meal.

The system then switches off until the cat owner reactivates it.

The electronic controls for the individual elements can be remote controlled, but since everything takes place in one room, a wired system with a wall socket connection would also be possible.

Naturally it would also be possible to install only one system (F1, LS1), but the cat would then sit too long and wait next to the food dish. It would then have to be driven off, for example by an acoustic noise or water or by throwing a treat far from F1 by means of a small catapult device and thus getting it away from F1. Then two light curtains would be needed to detect whether the cat moved in the direction of the food dish or away from it, and the food dish is then either activated or stopped.

This means that if light curtain LSA is passed first and then light curtain LSB, this results in a possible time-delayed resumption of the movement of the food dish.

If light curtain LSB is passed through first and then light curtain LSA, the food dish is pulled back. FIG. 3.

It is naturally also important in which sequence the light curtains are left in order to prevent the cat from making a quick turn half way. This means that if LSA is passed first, then LSB, LSB must be passed through first afterwards, otherwise the system continues to remain stopped.

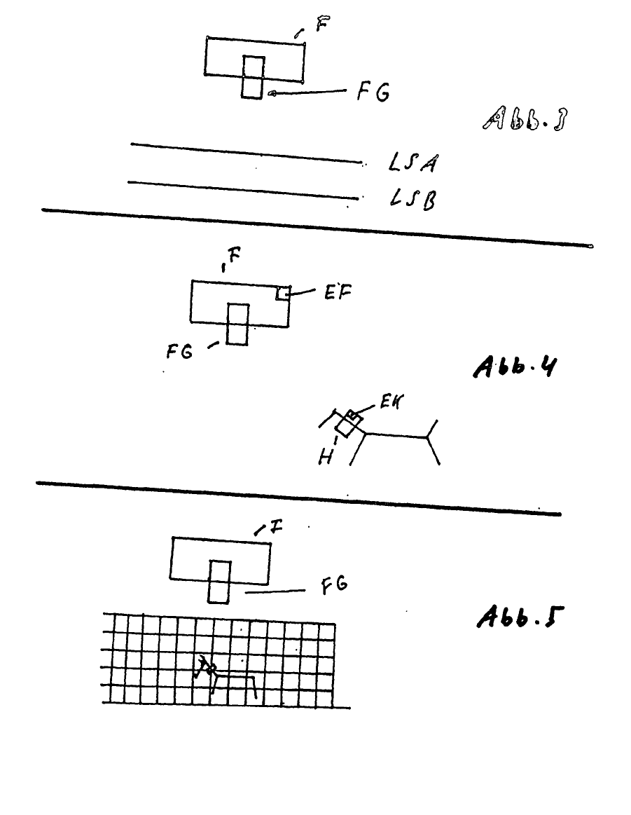

The cat can also wear appropriate receivers or transmitters EK by means of a collar which communicate with receivers and transmitters in the food bin EF, which would always define the cat's position precisely. FIG. 4.

All distance sensors, position sensors, control curtains or detection systems (e.g. laser, infrared, radio waves, etc.) known from the prior art could be used.

More complicated circuits would then be possible which always match the action of the food dish FG exactly to the specific position of the cat.

Squares could be defined by means of cables placed to report the exact position of the cat. FIG. 5.

Or magnetic or electromagnetic fields or other technical fields are generated and thus define areas.

Instead of the light curtains, arrangements with motion sensors would be conceivable which cover individual areas and cause the food to disappear when activated.

It is naturally also conceivable that the cat, with an enormous effort, can sometimes reach the moving food dish FG, stop it and eat all the food. Stopping the food dish, which is trying to move away with low force, using its paw or its mouth would then simulate the usual playing of the cat with the captured mouse. To do this, the design would naturally have to be such that the cat cannot hurt itself. Of course it is also possible that the cat cannot stop the moving food dish but has to fish out the food or treat.

It is naturally also conceivable that when the owner is present, he simply controls the movements of the food dish FG using a remote control. This would represent a completely separate device, but the special feature would be that the food dish FG can disappear temporarily, arousing the particular attention of the cat.

Mouse noises are also conceivable to stimulate the cat additionally.

These systems are, of course, also well suited to occupy other types of animals which function by stalking, etc., e.g. zoo animals (big cats).

Several measuring areas could actually be located between the two food bins F, for example, several light curtains LS, the activation of which by the cats results in highly varied movements of the food dish FG. FIG. 6.

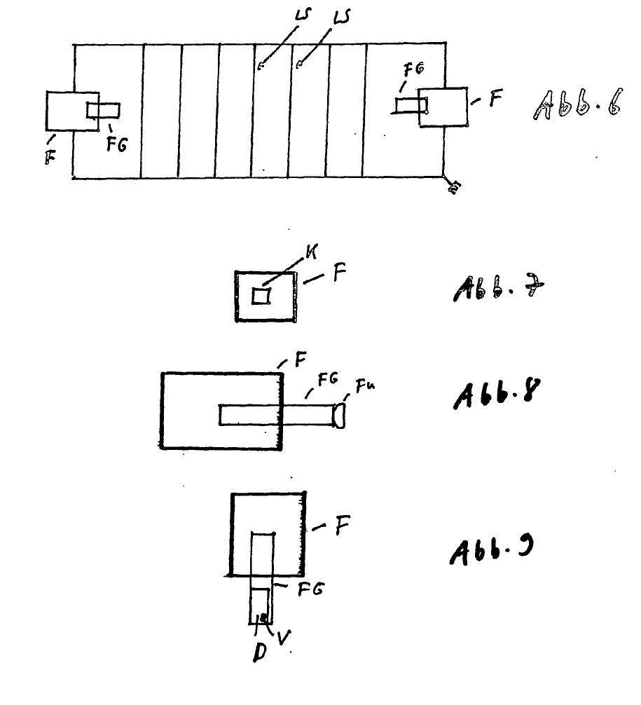

Pinching the cat's paw in the food bin as its retracts could be prevented by designs such as shown in FIG. 7 (front view). The food dish, which is configured as a piston, runs smoothly into the food bin F so that there is no gap where the cat can be pinched.

The food Fu is located in the forward part and is attached there at the end of the piston and is then removed by the cat when the piston comes to a stop outside. FIG. 8 (side elevation).

Or the food dish F has a tightly fitting cover D on top whose latch V opens automatically after being activated by a cat's paw. FIG. 9.

In the case of the dog, for example, the primary motivation is to run fast so that food shown disappears after a specific time, for example, by falling through a trap into a closed box so that the dog does not reach it if it does not run there quickly enough.

This refinement is intended to be a training aid for a dog. Only a tired dog is a good dog. Frequently the dog owner does not have enough time to take the dog out, perhaps not even to play in the garden.

This invention can offer an alternative and supplement the other, movements of the dog.

The dog is challenged without the need for a human to be present. For completing the task quickly, there is a treat, that is to say, the dog earns his food much as it would in nature, specifically by running fast and catching the prey.

The dog can also be encouraged thereby to run fast and pick up speed, this is important in particular for breeds which are very strong runners.

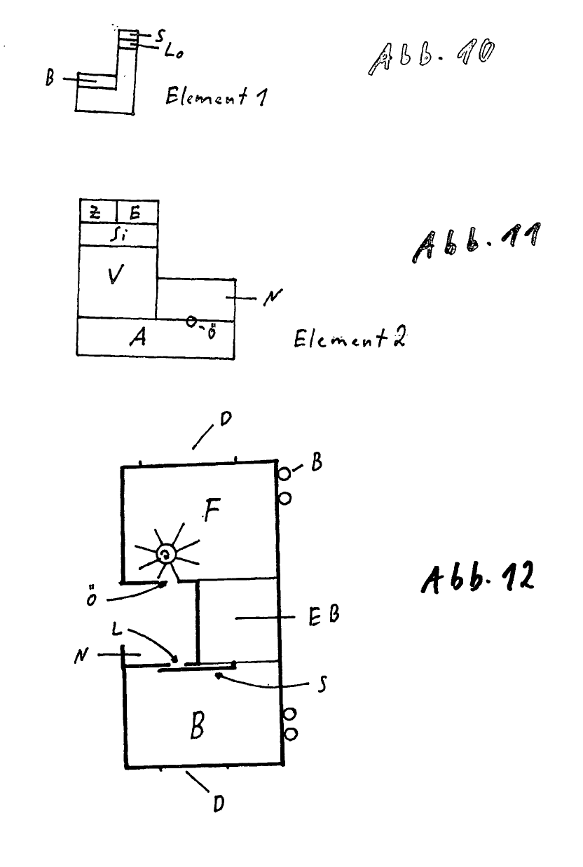

The invention consists in its simplest form of two elements which are positioned at any distance from each other, for example, in the garden 40 meters apart, in a field 100 meters, in the house 10 meters, etc. Element 1 contains an electronic transmitter S which sends a signal to the receiver E in element 2 after it is touched by the dog at contact point B. FIG. 10 and FIG. 11.

Element 2 contains the receiver. As soon as the receiver has received the signal from transmitter S, a timer Z is activated which releases a treat from the supply container V into the dish N.

The dish has an opening O underneath which opens after a specific time. If the dog has not fetched the treat by this time, it drops down through the opening into the catch area A and can no longer be reached by the dog.

After it is activated, the receiver will broadcast an acoustic signal (signal generator Si) which indicates to the dog that the treat is now available.

The acoustic signal can be configured, for example, such that three different pleasant tones are produced in succession so that the dog soon learns that it has to hurry in order to reach the dish by the third tone at the latest.

Additionally, a timer could also be located in element 1 which in accordance with a time to be set by the dog owner, for example, also emits an acoustic signal, a calling signal Lo, and thus indicates to the dog that the transmitter can be activated again by touch.

If the dog does not come immediately, it is reminded again by a later signal. A dog can be kept active for a specific time in this way.

When it is a matter of food, every dog is normally very willing to learn, the owner can show the dog how it is done by running with it at the start.

Other designs are conceivable, for example, in which the treat is extended through a hatch and is withdrawn after a specific time.

A plurality of arrangements are conceivable for the precise design, it is important that the dog does not injure itself even when rushing at the food and, on the other hand, that it cannot destroy or tip over the elements, suggesting for example a structure of metal or similarly strong plastic, wood, or other sturdy materials and the entire structure is as low as possible so that it does not tip over quickly.

It is possible that attachments will be required to secure it in a field, for attaching it to a fixed point or the possibility of weighting the whole thing, for example with a rock.

The closing mechanism for the dish or other means of offering treats must be designed such that it is not possible to trap the mouth, nose or tongue.

Different treats or toys, etc. could be released in rotation in different compartments in order to surprise the dog and keep it happy.

Instead of acoustic signals, other signals to which the dog reacts well are also conceivable, e.g. light signals or movements from a mechanical arm on element 1 or 2 for example, or stored words and commands from his owner (digital voice recorder).

If the dog continues to occupy itself for a very long time with element 1 or 2 after the game is over, by attacking and chewing for example, an arrangement could be set up for example which, after a specific time, makes an unpleasant noise which temporarily drives the dog away.

Or the structure could be made such that both elements operate alternately as transmitter and receiver and thus guide the dog from one station to the next.

If it has just fetched its reward at element 1, the signal sounds at element 2 after a specific time so that it has to run there quickly.

Elements 1 and 2 would have to be coordinated with each other so that they always attract the dog alternately. It would be ideal if the intervals are constantly varied and thus keep matters exciting.

If the dog has just received its treat at element 1, after a specific time the prompt signal sounds at element 1 for the first time, for example, which challenges it to set off the acoustic signal at element 2 by touching the contact switch in element 1. This procedure would ensure that it has to cover the entire distance from 1 to 2 in the time determined.

Element 1 and 2 could then be constructed to be completely identical.

Naturally, the two modules could also be operated totally independently of each other and thus it would be left to chance where the dog is when the food-ready signal sounds. Thus, one single apparatus could achieve a specific exercise effect.

However, it would be better if a certain interval measurement were sent by a radio signal or a transit sensor or movement sensor to ensure that the animal is a certain distance away at the food-ready signal. For this, it might be necessary to attach a transmitter/receiver to the dog's collar.

In theory, the time intervals should be set such that the dog is challenged but not overextended, that in most cases it has a successful experience when it cooperates.

Naturally a proper jumping course with several elements would also be conceivable where the dog constantly receives a reward after completing specific tasks, for example jump up onto an object etc. The elements would be coordinated with each other.

Different inventions have already been presented which are intended to provide a dog with more movement.

For example, DE 29821473, a food-dispensing toy. The approach is a different one, running fast is not important.

Or DE 29903105 a controllable ball, the path on which the ball and the dog move cannot be calculated.

DE 20301419, at night it is better if the dog moves in a supervised area.

Different devices have been presented which alternately dispense food for animals, however not in conjunction with a competitive game. (DE 20002121, DE 29508575, DE 3744337)

The entire object is also conceivable for other types of animal, for example as exercise for zoo animals or in the horse sphere.

A more exact embodiment of the invention already mentioned in DE 10 2004 041 001.1 could look thus. FIG. 12.

Element 1 consists of a touch sensor, a light curtain, a motion sensor or other position sensor.

If the presence of the dog is reported there, element 1 transmits a message to element 2 by means of a radio signal.

In the center section there is an electronic area EB which receives the signal.

It causes a pleasant acoustic signal to sound which signals to the dog that a treat has dropped into the dish N.

The individual treat is controlled through the electronic area, released by means of the grid mechanism RM (for example, as with a chewing gum dispenser) from the food area F through the opening Ö into the dish N.

The dish N has a hole L in the bottom which is closed by a slide S. Controlled by the electronic area KE, the slide S is pulled back after a specific time interval so that the treat falls into the space B where the dog can no longer reach it. (Timer)

Element 2 has a cover D on its upper and lower end D, where the owner can refill or remove treats after unscrewing the lid. In the rear area element 2 has fasteners B, in the form of buckles, eyelets, hooks or other elements to attach cord, wire or similar. They serve to attach element 2 to a tree, a post, etc. or to weigh it down with a heavy object (e.g. stone). This is intended to stabilize element 2 when the dog comes running up.

This version of element 2 shown can of course be provided in a wide variety of individual designs.

It would also be possible, for example, for food to be in only one dish and for the cover to open and close quickly.

But element 1 is necessary which forces the dog to run quickly from dish 1 to dish 2.

When the owner is present, element 2 could of course be remote controlled.

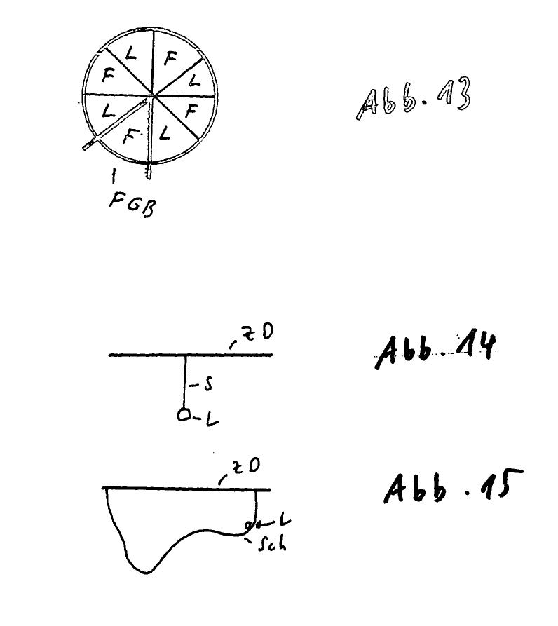

A variant would also be possible in which, for example, 8 food dishes constantly release a new food dish by rotating (release area FGB). Each second food dish F has food, the other food dishes would be empty L and appear when the dog takes too much time. FIG. 13.

One variant which appears particularly suited for dogs, would be a design in which a food dispenser, e.g. would be mounted, for example, to a room ceiling ZD or some other high attachment point, for example a tree, and, for example constantly releases a treat L downward by means of a string or a rubber cord, etc. (as in bungee jumping).

If the dog is not there fast enough, the treat is pulled up again and is no longer reachable. FIG. 14.

Instead of the treat, lowering a sturdy toy would also be conceivable (teething rope, training dummy, play ring, cotton rope bone). This is similarly removed after a specific time or by activating a position sensor, in this case unreachable in the direction of the ceiling.

It would also be possible that the dog reaches the toy in time and it can play with it for a longer or shorter period of time before it is removed again by being pulled up. The prerequisite would be that the entire arrangement is a very stable construction. (rope, wire rope, chain, sturdy toy, etc.)

Or the treat L would move along a rail Sch which only allows the dog to seize it intermittent over a specific distance. FIG. 15.

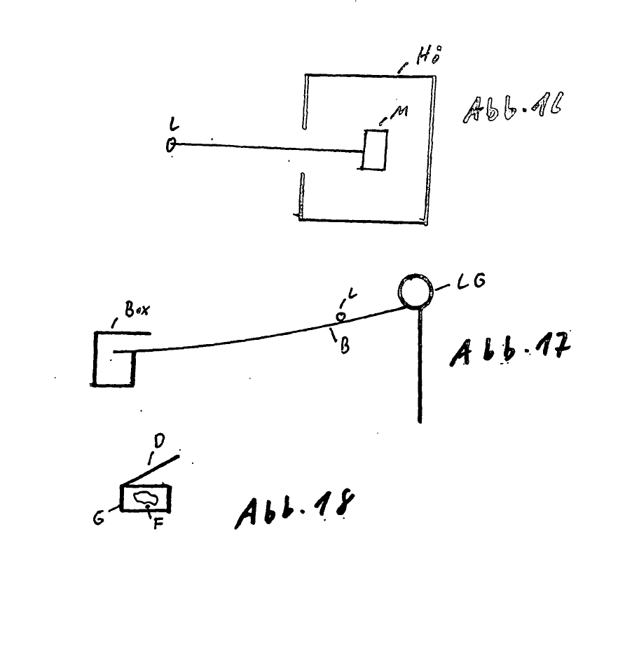

Another variant would be for the treat to disappear slowly so that the dog can see it and is stimulated to run quickly. For example, by a mechanism M slowly pulling or moving it into a recess. FIG. 16

Or if it is pulled slowly up to the ceiling, where it cannot be reached by the dog after a certain height. FIG. 17

Or the preferably round treat L is released from the treat container LG and runs slowly down a track B where it can be caught by the animal.

However, if it has reached the end of the track, it rolls into a box and is thus unreachable. FIG. 18

Naturally variants are conceivable where food F is offered in a container G and is afterwards unobtainable again due to a self-closing lid D. FIG. 19

The time interval after which another treat is released can be left to chance, as can the time interval for how long the treat is offered before it disappears. (timer with random program)

Or the two time intervals are determined in advance by the owner.

Equipment which measures whether the animal is at a particular location or not can be directly integrated in the treat dispenser or operate as external secondary equipment.

A motion sensor integrated in the apparatus, possibly using infrared measurement registers when no living creature is in the vicinity and then releases a treat. It could also operate time-controlled, for example being switched on only every 5 minutes and if it then registers nothing, releases a treat.

This or a second motion sensor could also be used to remain active after a treat has been released and then measures if the animal approaches. This approach would then cause the treat to disappear.

Every known technical module can be used for the structures.

For example, infrared sensors, video surveillance systems, camera systems with surveillance function, floor alarm mats, differential alarm loops, time relays with magnetic contacts, chip cards, RF transponders, magnetic cards, heat sensors, vibration sensors, films with sensors, ultrasound echo distance warning, laser light curtains, timers with random programming, a wide variety of radio systems and wireless transmission systems with a broad variety of ranges and frequencies, wired systems with wall socket connection, etc.

The entire construction should be water-tight since electricity is involved. It should also be bite-resistant so that it cannot be taken apart by a dog, for example. It can also be suspended at a great height.

It can also be designed to be soft in part, where, for example, the danger exists that an animal can be injured, for example, by being pinched.

For example a dog can be attracted by odors. This could take the form of a treat in air-tight packaging which is released to the dog from an air-tight box without additional signs. The dog then has 5 minutes, for example, to reach the food, otherwise it disappears again, or it disappears as the result of a message from a position sensor, and the game begins again later.

In particular, provision is made that in addition to food other attractive objects or toy(s) can be offered and the same applies to them as was said for the food.

In an advantageous embodiment of the invention, provision is made for the accessibility of food to be made by means of a device for food accessibility. In accordance with a refinement of the invention, provision is made for the inaccessibility of food to be made by means of a device to make the food inaccessible.

In an advantageous embodiment of the invention, provision is made for the food dish to be controlled remotely by the owner, but also to operate independently without the presence of the owner.

In accordance with a refinement of the invention, provision is made for the food dish to run like a piston without a gap in the cavity of the food dispenser. In an advantageous embodiment of the invention, provision is made for the food to be attached at the front of the piston or is available by way of a cover which is then opened by the animal itself.

Provision is further advantageously made for a treat/toy to be dispensed from a supply bin and for it is to be made inaccessible if it is not fetched in time by the animal within an adjustable time interval.

In an advantageous embodiment of the invention, provision is made for the dog to be constantly challenged independently to play by the system, and for the sequence to run independently after being programmed previously without the need for a person to be present, and by its design it is ensured that the dog has to run in a specific time from one element to the other in order to be successful.

In accordance with a refinement of the invention, provision is made for the play area and the intervals and rewards to be stipulated by the owner, and the dog is motivated to run quickly, thereby also satisfying his instinct for prey.

In accordance with an advantageous embodiment of the invention, provision is made for the dog to be controlled principally by acoustic signals, or by light stimuli or movements, or stored commands from his owner or olfactory influences and for the specific intervals to be controlled by adjustable timers.

In an advantageous embodiment of the invention, provision is made for element 1 and 1 to be designed as a unit and their signals and so on are matched to each other by previous programming.

In accordance with a refinement of the invention, provision is made for a certain distance of the dog from element 2 to be determined by element 1 in the form of a light curtain, a motion sensor, a contact sensor or similar.

In an advantageous embodiment of the invention, provision is made for an electronic area in element 2 to control signal reception, acoustic signal, grid mechanism for releasing the treat, opening the slide to make the treat disappear, as well as the inclusion of timers.

In accordance with a refinement of the invention, provision is made for element 1 and also element 2 to have attaching elements on the outside to prevent the elements from toppling.

In an advantageous embodiment of the invention, provision is made that element 2, can have a highly varied appearance as long as it is ensured that a treat or food is only offered occasionally.

In accordance with a refinement of the invention, provision is made for the food dispenser to be attached to a room ceiling or to another elevated spot which is not accessible to the animal, and from there a treat is sent downward and later pulled up again so that it can no longer be reached by the animal, for example a dog.

In an advantageous embodiment of the invention, provision is made for the treat to disappear slowly while the animal can see it and thus motivate it to run.

In accordance with a refinement of the invention the treat is pulled slowly upward.

In an advantageous embodiment of the invention the treat is pulled slowly into a cavity.

In a refinement of the invention the intention is for the treat to roll down a track and then disappear in a box or a hole.

In an advantageous refinement of the invention, the treat is offered in a container and is then covered by a self-closing cover.

In accordance with a refinement of the invention, provision is made for a previously air-tight sealed treat to be released at a specific time so that the animal, for example a dog, can now detect it by means of smell.

The invention relates to a method of stimulating movement in an animal, in particular a dog or a cat, using a food delivery device.

The intention is for the food delivery device to make a serving of food available and then make it inaccessible again before the animal reaches it. In accordance with a refinement of the invention, the intent is that the food delivery device makes a serving of food accessible and then, after it has been reached by the animal, makes it inaccessible again.

In an advantageous embodiment of the invention, the intention is that the previous claims do not apply only to treats, but also to toy and other attractive objects and that this food and objects vary depending on the type of animal.

In accordance with a refinement of the invention, the intention is that such arrangements can be used with all types of animal, even for the human animal (e.g. children's play, stimulus for completing tasks, sports equipment).

1.-39. (canceled)

40. Animal exercise device, comprising a food provision device that makes a serving of food or a toy accessible and subsequently, before the animal reaches it, makes it inaccessible again or from time to time makes it accessible long enough so that—in order to maintain its motivation—the animal reaches the serving of food or the toy.

41. Animal exercise device from claim 40, wherein a moving food dish is connected to position detection systems which determine the position of the animal, for example of a cat, and then control the movement of the food dish accordingly.

42. Animal exercise device according to claim 41, wherein the food dish occasionally disappears in a food bin and moves at different intervals and speeds and thus challenges the natural instincts of the animal, for example, a cat.

43. Animal exercise device according to claim 40, wherein the position detections systems for detecting the position of the animal are specifically light curtains, motion sensors, distance sensors, position sensors, control barriers, detection systems or systems having elements which can be integrated in a collar.

44. Animal exercise device according to claim 40, wherein the attention of the animal is constantly aroused by means of a corresponding or also independently operating second food dish (second system).

45. Animal exercise device according to claim 40, wherein the system remains in operation even without a second food dish, by determining the direction of the animal's movement by means of position detection systems.

46. Animal exercise device according to claim 41, wherein the sequence is stopped after a specific time or a particular progression, or the animal catches the food dish while it is moving.

47. Animal exercise device according to claim 40, wherein the animal exercise device comprises first and second elements, where the first element, after it is touched by a dog, acts as transmitter which sends a signal to the second element where, specifically by means of a timer, for a certain time a serving of food is released as a treat and thus the dog is stimulated to run quickly from the first element to the second element.

48. Animal exercise device according to claim 40, wherein two identical elements can operate in concert with each other or not in concert with each other and can be operated independently of each other.

49. Animal exercise device according to claim 40, wherein a single element operates with distance measurement, specifically by a radio signal or a passage sensor or a motion sensor.

50. Animal exercise device according to claim 47 wherein the food container or second element can be controlled by the owner when he is present means of a remote control.

51. Animal exercise device according to claim 40, wherein the treat for the animal lies recognizably motionless and any additional signals (sound, light) indicate to the animal that a treat is available, before a timer or a position sensor causes the treat to disappear again after a specific time.

52. Animal exercise device according to claim 40, wherein the time intervals in which food is offered, and the time intervals for how long it is available are determined randomly, in particular by means of a timer with random programming, or are set by the owner.

53. Animal exercise device according to claim 40, wherein position detection elements which detect whether the animal is in the vicinity or not, are integrated in the treat dispenser or operate as a secondary external device, where a second position detection element is not required.

54. Method for stimulating movement in an animal, in particular a dog or a cat, having a food provision device, wherein the food provision device makes a serving of food or a toy accessible and subsequently, before the animal reaches it, makes it inaccessible again or from time to time makes it accessible long enough for the animal—in order to maintain its motivation—to reach the food or the toy.
